(19) United States
(12) Patent Application Publication
(10) Pub. No.: US 2026/0302240 A1
(43) Pub. Date: Oct. 1, 2026

(54) SECONDARY BATTERY AND METHOD FOR MANUFACTURING POSITIVE ELECTRODE FOR SECONDARY BATTERY

(71) Applicant: HONDA MOTOR CO., LTD., Tokyo (JP)

(72) Inventor: Toshiyuki ARIGA, Saitama (JP)

(21) Appl. No.: 19/562,790

(22) Filed: Mar. 11, 2026

(30) Foreign Application Priority Data
Mar. 31, 2025 (JP) 2025-060101

(51) Int. Cl. H01M 4/62; H01M 4/36; H01M 4/02

(52) U.S. Cl. CPC H01M 4/621; H01M 4/366; H01M 2004/021; H01M 2004/028

(57) ABSTRACT

A positive electrode for a secondary battery, according to an embodiment of the present invention, includes a positive electrode current collector, a positive electrode active material layer layered at least partially on a surface of the positive electrode current collector, a first covering layer covering a portion of the positive electrode current collector, the portion being not layered with the positive electrode active material layer, and a second covering layer disposed between the positive electrode current collector and the positive electrode active material layer.

This application is based on and claims the benefit of priority from Japanese Patent Application No. 2025-060101, filed on 31 Mar. 2025, the content of which is incorporated herein by reference.

### BACKGROUND OF THE INVENTION

### Field of the Invention

The present invention relates to a secondary battery and a method for manufacturing a positive electrode for the secondary battery.

### Related Art

In recent years, research and development regarding secondary batteries, which contribute to the enhancement of energy efficiency, has been performed in order to ensure that more people have accesses to convenient, reliable, sustainable, and advanced energy at reasonable cost. Lithium ion secondary batteries that use lithium ions as a charge-transfer medium and that are thus high in voltage, capacity, and energy density, among the secondary batteries, are utilized in fields of, for example, in particular, mobile phones, storage batteries for wind and photovoltaic electric power generation facilities, electric vehicles, and smart grids. As a secondary battery, there is known a configuration in which lithium is deposited on a negative electrode during charging.

To prevent short-circuiting in a battery interior of a secondary battery, it has been considered that an exposed portion of a positive electrode current collector be covered with an insulating material (for example, see Patent Document 1 and Patent Document 2).

Patent Document 1: PCT International Publication No. WO2015/046537

Patent Document 2: Japanese Unexamined Patent Application, Publication No. 2020-123536

### SUMMARY OF THE INVENTION

By the way, one theme in techniques regarding secondary batteries is enhancement of safety. In lithium ion secondary batteries, enhancement of safety when a temperature is high is important. In a lithium ion secondary battery having such a configuration in which lithium is deposited on a negative electrode during charging, in particular, lithium deposited on the negative electrode melts when a temperature is high, that is, when the temperature is 180°C, the melted lithium flows toward a positive electrode and comes into contact with a positive electrode current collector, possibly causing the positive electrode and the negative electrode to be short-circuited. Although covering an exposed portion of a positive electrode current collector with an insulating material is effective as a method for preventing short-circuiting between a positive electrode and a negative electrode, it is difficult to cover a surface of the positive electrode current collector formed with a positive electrode active material layer with an insulating material without creating a gap.

In view of such issues described above, an object of the present invention is to provide a secondary battery that is superior in safety since short-circuiting rarely occurs even when lithium melts in a battery interior and a method for manufacturing a positive electrode for a secondary battery, which is applicable to the secondary battery. Then, the present invention is one that contributes to more efficient energy.

(1) A secondary battery including: a positive electrode; a negative electrode; and an electrolyte, in which the negative electrode forms a metal layer including lithium upon charging, the positive electrode includes a positive electrode current collector, a positive electrode active material layer layered at least partially on a surface of the positive electrode current collector, a first covering layer covering a portion of the positive electrode current collector, the portion being not layered with the positive electrode active material layer, and a second covering layer disposed between the positive electrode current collector and the positive electrode active material layer, a surface resistance value of the first covering layer at 20°C is higher than a surface resistance value of the second covering layer at 20°C, the surface resistance value of the second covering layer at 20°C is higher than a surface resistance value of the positive electrode current collector at 20°C, an end portion of the second covering layer, the end portion being on a first covering layer side, has an extension portion that extends beyond an end portion of the positive electrode active material layer toward the first covering layer side, and the extension portion of the second covering layer is disposed on the first covering layer or between the first covering layer and the positive electrode current collector.

According to the secondary battery described in (1), since the first covering layer and the extension portion of the second covering layer cover the positive electrode current collector, even when lithium on the negative electrode melts and flows toward the positive electrode, the flowed lithium comes into contact with the first covering layer or the extension portion of the second covering layer, and rarely comes into direct contact with the positive electrode current collector. Then, the surface resistance value of each of the first covering layer and the second covering layer at 20°C is higher than the surface resistance value of the positive electrode current collector at 20°C. Therefore, compared with a case where the flowed lithium comes into contact with the positive electrode current collector, an amount of a current flowing between the positive electrode and the negative electrode is reduced, as the flowed lithium comes into contact with the first covering layer and the extension portion of the second covering layer, making it possible to reduce the amount of heat generated.

(2) The secondary battery described in (1), in which the extension portion of the second covering layer is disposed on the first covering layer, and an end portion of the first covering layer, the end portion being on a second covering layer side, has an extension portion that extends beyond the end portion of the positive electrode active material layer and covers at least partially the positive electrode current collector.

According to the secondary battery described in (2), since the extension portion of the second covering layer is disposed on the first covering layer, and the first covering layer has the extension portion that extends beyond the end portion of the positive electrode active material layer and covers at least partially the positive electrode current collector, a gap is rarely created between the first covering layer and the second covering layer, making it possible to further securely achieve covering of the positive electrode current collector.

(3) The secondary battery described in (1) or (2), in which the surface resistance value of the first covering layer at 20°C is 10 times or more of the surface resistance value of the positive electrode current collector at 20°C.

According to the secondary battery described in (3), since the surface resistance value of the first covering layer at 20°C is high, when flowed lithium comes into contact with the first covering layer, the current flowing between the positive electrode and the negative electrode can be reduced, making it possible to securely reduce the amount of heat generated.

(4) The secondary battery described in any one of (1) to (3), in which a thickness of the first covering layer falls within a range from 0.1 μm or more to 10.0 μm or less.

According to the secondary battery described in (4), since the first covering layer is thicker in thickness, when flowed lithium comes into contact with the first covering layer, the current flowing between the positive electrode and the negative electrode can be further securely reduced, making it possible to further securely reduce the amount of heat generated.

(5) The secondary battery described in any one of (1) to (4), in which the surface resistance value of the second covering layer at 20°C falls within a range of 10 times or more of the surface resistance value of the positive electrode current collector at 180°C.

According to the secondary battery described in (5), since the surface resistance value of the second covering layer at 20°C falls within the range described above, it is possible to maintain an electrically conductive property between the positive electrode current collector and the positive electrode active material layer, when flowed lithium comes into contact with the extension portion of the second covering layer, the current flowing between the positive electrode and the negative electrode can be reduced, making it possible to securely reduce the amount of heat generated.

(6) The secondary battery described in any one of (1) to (5), in which the first covering layer includes electrically insulating particles and a binder.

According to the secondary battery described in (6), since the first covering layer includes the binder, it is possible to achieve covering of the positive electrode current collector with high adhesion.

(7) The secondary battery described in (6), in which the electrically insulating particles are metal oxide particles or metal hydroxide particles.

According to the secondary battery described in (7), since the first covering layer includes metal oxide particles or metal hydroxide particles, the surface resistance value of the first covering layer at 20°C can fall within the range described above.

(8) The secondary battery described in (7), in which the metal oxide particles are oxide particles of aluminum, and the metal hydroxide particles are hydroxide particles of aluminum or aluminum oxide.

According to the secondary battery described in (8), since the first covering layer includes oxide particles of aluminum or hydroxide particles of aluminum or aluminum oxide, the surface resistance value of the first covering layer at 20°C can further securely fall within the range described above.

(9) The secondary battery described in any one of (6) to (8), in which a mean particle diameter of the electrically insulating particles is 0.1 μm or less.

According to the secondary battery described in (9), the first covering layer includes fine electrically insulating particles, becomes minute and strong, and is rarely broken even when lithium comes into contact with the layer.

(10) The secondary battery described in any one of (1) to (9), in which the second covering layer includes electrically conductive particles and a binder.

According to the secondary battery described in (10), since the second covering layer includes the binder, the extension portion of the second covering layer and the first covering layer can come into contact with each other with high adhesion.

(11) A method for manufacturing a positive electrode for a secondary battery, including: applying and drying an application liquid for forming a first covering layer on a surface of a positive electrode current collector to form the first covering layer; applying and drying an application liquid for forming a second covering layer to form the second covering layer in such a manner that the first covering layer is at least partially exposed; applying and drying an application liquid for forming a positive electrode active material layer on a surface of the second covering layer, excluding an end portion where the second covering layer covers the first covering layer, to form the positive electrode active material layer; and pressing a surface of the positive electrode active material layer.

According to the method for manufacturing the positive electrode for the secondary battery, described in (11), since the first covering layer and the second covering layer are formed in this order, it is possible to manufacture industrially advantageously the positive electrode for the secondary battery, in which the extension portion of the second covering layer is disposed on the first covering layer.

(12) The method for manufacturing the positive electrode for the secondary battery, described in (11), in which the application liquid for forming the first covering layer includes a first solvent, a first binder dissolved in the first solvent, and electrically insulating particles dispersed in the first solvent, the application liquid for forming the second covering layer includes a second solvent, a second binder dissolved in the second solvent, and electrically conductive particles dispersed in the second solvent, and the first binder is highly soluble in the second solvent.

According to the method for manufacturing the positive electrode for the secondary battery, described in (12), since the first binder is highly soluble in the second solvent, the first binder in the first covering layer is easily dissolved when the second covering layer is to be formed. As the first binder in the first covering layer is dissolved, the electrically conductive particles diffuse in the first covering layer, and the surface resistance value of the first covering layer that is positioned below the second covering layer at 20°C decreases.

(13) The method for manufacturing the positive electrode for the secondary battery, described in (11) or (12), in which the positive electrode current collector has an elongated shape, the first covering layer is continuously formed in a longer direction of the elongated positive electrode current collector, the second covering layer is intermittently formed on a surface of the first covering layer in the longer direction of the elongated positive electrode current collector in such a manner that the first covering layer is at least partially exposed, the positive electrode active material layer is intermittently formed on a surface of the second covering layer in the longer direction of the elongated positive electrode current collector, and cutting into a shape of the positive electrode is then performed.

According to the method for manufacturing the positive electrode for the secondary battery, described in (13), since the elongated positive electrode current collector is used and the first covering layer and the second covering layer are formed in this order, it is possible to continuously manufacture the positive electrode for the secondary battery, in which the extension portion of the second covering layer is disposed on the first covering layer.

(14) A method for manufacturing a positive electrode for a secondary battery, including: applying and drying an application liquid for forming a second covering layer partially on a surface of a positive electrode current collector to form the second covering layer; applying and drying an application liquid for forming a first covering layer to form the first covering layer in such a manner that the second covering layer is at least partially covered; applying and drying an application liquid for forming a positive electrode active material layer on a surface of the second covering layer, excluding an end portion where the first covering layer covers the second covering layer, to form the positive electrode active material layer; and pressing a surface of the positive electrode active material layer.

According to the method for manufacturing the positive electrode for the secondary battery, described in (14), since the first covering layer is formed on the second covering layer, it is possible to manufacture industrially advantageously the positive electrode for the secondary battery, in which the extension portion of the second covering layer is disposed between the first covering layer and the positive electrode current collector.

(15) The method for manufacturing the positive electrode for the secondary battery, described in (14), in which the application liquid for forming the first covering layer includes a first solvent, a first binder dissolved in the first solvent, and electrically insulating particles dispersed in the first solvent, the application liquid for forming the second covering layer includes a second solvent, a second binder dissolved in the second solvent, and electrically conductive particles dispersed in the second solvent, and the second binder is poorly soluble in the first solvent.

According to the method for manufacturing the positive electrode for the secondary battery, described in (15), since the second binder is poorly soluble in the first solvent, the second binder in the second covering layer is rarely dissolved when the first covering layer is to be formed. Since the second binder in the second covering layer is not dissolved, the electrically conductive particles rarely diffuse in the first covering layer. The positive electrode to be acquired is therefore high in surface resistance value of the first covering layer at 20°C.

(16) The method for manufacturing the positive electrode for the secondary battery, described in (14) or (15), in which the positive electrode current collector has an elongated shape, the second covering layer is intermittently formed in a longer direction of the elongated positive electrode current collector, the first covering layer is intermittently formed in a longer direction of the elongated positive electrode current collector in such a manner that the second covering layer is at least partially covered, the positive electrode active material layer is intermittently formed on a surface of the second covering layer in the longer direction of the elongated positive electrode current collector, and cutting into a shape of the positive electrode is then performed.

According to the method for manufacturing the positive electrode for the secondary battery, described in (16), since the elongated positive electrode current collector is used to form the second covering layer and the first covering layer, it is possible to continuously manufacture the positive electrode for the secondary battery, in which the extension portion of the second covering layer is disposed between the first covering layer and the positive electrode current collector.

According to the present invention, it is possible to provide a secondary battery that is superior in safety since short-circuiting rarely occurs even when lithium melts in a battery interior and a method for manufacturing a positive electrode for a secondary battery, which is applicable to the secondary battery.

### BRIEF DESCRIPTION OF THE DRAWINGS

FIG. 1 is a cross-sectional view of a secondary battery according to an embodiment of the present invention;

FIG. 2 is a cross-sectional view illustrating a first embodiment of a positive electrode that is usable in the present invention;

FIG. 3 is a cross-sectional view illustrating a second embodiment of the positive electrode that is usable in the present invention;

FIG. 4A is a plan view illustrating a step of forming a first covering layer in a method for manufacturing the positive electrode according to the second embodiment;

FIG. 4B is a cross-sectional view taken along a line IVB-IVB illustrated in FIG. 4A;

FIG. 5A is a plan view illustrating a step of forming a second covering layer in the method for manufacturing the positive electrode according to the second embodiment;

FIG. 5B is a cross-sectional view taken along a line VB-VB illustrated in FIG. 5A;

FIG. 6A is a plan view illustrating a step of forming a positive electrode active material layer in the method for manufacturing the positive electrode according to the second embodiment;

FIG. 6B is a cross-sectional view taken along a line VIB-VIB illustrated in FIG. 6A;

FIG. 7 is a plan view illustrating a step of performing cutting into a shape of the positive electrode in the method for manufacturing the positive electrode according to the second embodiment;

FIG. 8 is a cross-sectional view illustrating a third embodiment of the positive electrode that is usable in the present invention;

FIG. 9A is a plan view illustrating a step of forming a second covering layer in a method for manufacturing the positive electrode according to the third embodiment;

FIG. 9B is a cross-sectional view taken along a line IXB-IXB illustrated in FIG. 9A;

FIG. 10A is a plan view illustrating a step of forming a first covering layer in the method for manufacturing the positive electrode according to the third embodiment;

FIG. 10B is a cross-sectional view taken along a line XB-XB illustrated in FIG. 10A;

FIG. 11A is a plan view illustrating a step of forming a positive electrode active material layer in the method for manufacturing the positive electrode according to the third embodiment;

FIG. 11B is a cross-sectional view taken along a line XIB-XIB illustrated in FIG. 11A; and

FIG. 12 is a plan view illustrating a step of performing cutting into a shape of the positive electrode in the method for manufacturing the positive electrode according to the third embodiment.

### DETAILED DESCRIPTION OF THE INVENTION

Embodiments of the present invention will now be described herein with reference to the accompanying drawings. However, the embodiments described below merely exemplify the present invention. The present invention is not limited to the below description.

### First Embodiment

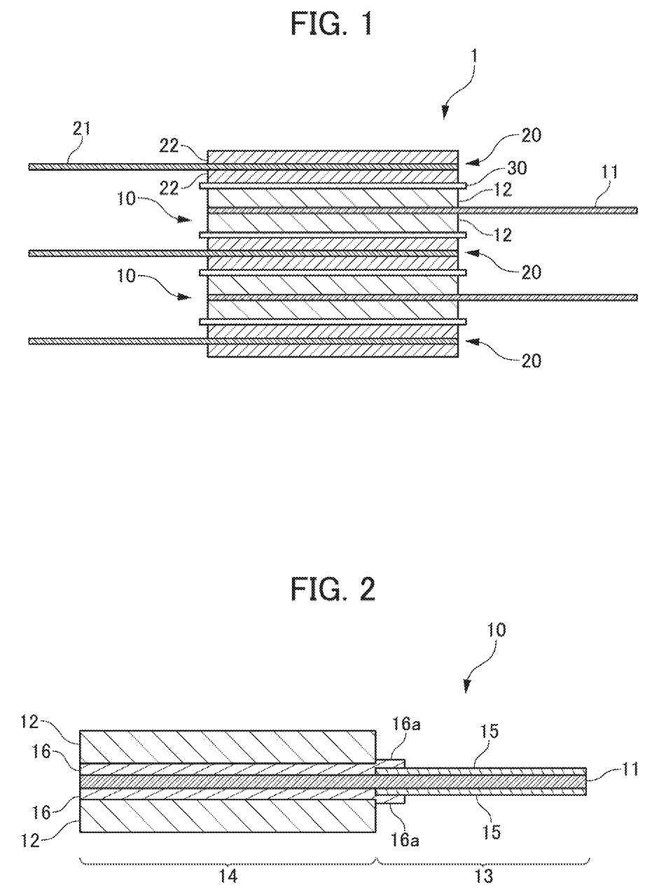

FIG. 1 is a cross-sectional view of a secondary battery according to an embodiment of the present invention. FIG. 2 is a cross-sectional view illustrating a first embodiment of a positive electrode that is usable in the present invention.

As illustrated in FIG. 1, a secondary battery 1 includes positive electrodes 10, negative electrodes 20, and electrolytes 30.

The positive electrodes 10 each include a positive electrode current collector 11 and positive electrode active material layers 12. The positive electrode active material layers 12 are respectively layered on both surfaces of the positive electrode current collector 11. The positive electrode active material layers 12 are partially layered on the positive electrode current collector 11. A portion 13 of the positive electrode current collector 11, the portion being not layered with the positive electrode active material layers 12, is covered with first covering layers 15. A portion 14 that is layered with the positive electrode active material layers 12 is disposed with second covering layers 16 each between each of the positive electrode active material layers 12 and the positive electrode current collector 11. An end portion of each of the second covering layers 16, the end portion being on the first covering layers 15 side, has an extension portion 16a that extends beyond an end portion of each of the positive electrode active material layers 12 toward each of the first covering layers 15. The extension portion 16a of each of the second covering layers 16 is disposed on each of the first covering layers 15.

A surface resistance value of each of the first covering layers 15 at 20°C is higher than a surface resistance value of each of the second covering layers 16 at 20°C, and the surface resistance value of each of the second covering layers 16 at 20°C is higher than a surface resistance value of the positive electrode current collector 11 at 20°C. That is, in terms of the surface resistance value at 20°C, the first covering layer 15 is highest, the second covering layer 16 is next highest, and the positive electrode current collector 11 is lowest. The surface resistance value of each of the first covering layers 15 at 20°C may be, for example, 10 times or more of the surface resistance value of the positive electrode current collector 11 at 20°C. The surface resistance value of each of the first covering layers 15 at 20°C may be, for example, 1 Ω/sq. or higher. The surface resistance value of each of the second covering layers 16 at 20°C may fall, for example, within a range of 10 times or more of the surface resistance value of the positive electrode current collector 11 at 20°C. The surface resistance value of each of the second covering layers 16 at 20°C may be, for example, 1 Ω/sq. or higher. A thickness of each of the first covering layers 15 may fall, for example, within a range from 0.1 μm or more to 10.0 μm or less. A thickness of each of the second covering layers 16 may fall, for example, within a range from 0.1 μm or more to 3.0 μm or less. The thickness of each of the second covering layers 16 may be thinner than a thickness of each of the extension portions 16a of the second covering layers 16.

The first covering layers 15 may each be a layer including electrically insulating particles and a binder. The electrically insulating particles may be, for example, metal oxide particles or metal hydroxide particles. The metal oxide particles may be, for example, aluminum oxide particles. The metal hydroxide particles may be, for example, hydroxide particles of aluminum or hydroxide particles of aluminum oxide. Aluminum oxide may be, for example, Al₂O₃, and aluminum hydroxide may be, for example, Al(OH)₃ or hydroxide of aluminum oxide AlO(OH). An amount of content of the electrically insulating particles in each of the first covering layers 15, although which is not limited in particular, falls, for example, within a range from 90 mass% or higher to 99 mass% or lower. A mean particle diameter of the electrically insulating particles may be, for example, 0.1 μm or less.

The second covering layers 16 may each be a layer including electrically conductive particles and a binder. As the electrically conductive particles, it is possible to use particles of metal that rarely forms alloy with lithium and particles of a carbon material. Examples of the metal that rarely forms alloy with lithium include nickel, titanium, gold, and platinum. A mean particle diameter of the electrically conductive particles may be, for example, 0.1 μm or less. It is sufficient that an amount of content of the electrically conductive particles in each of the second covering layers 16 be an amount of content that allows the surface resistance value of each of the second covering layers 16 at 20°C to fall within the range described above, and, for example, within a range from 10 mass% or higher to 99 mass% or lower or within a range from 20 mass% or higher to 80 mass% or lower. The second covering layers 16 may each include electrically insulating particles. The electrically insulating particles included in each of the second covering layers 16 may be identical to or different from the electrically insulating particles in each of the first covering layers. Particles of a resin material may be used as the electrically insulating particles in each of the second covering layers 16.

Example materials of the positive electrode current collector 11 include aluminum, aluminum alloy, stainless steel, nickel, iron, and titanium.

As a material of each of the positive electrode active material layers 12, it is possible to use a composition including a positive electrode active material, a conductive auxiliary agent, and a binder. Examples of the positive electrode active material include lithium cobalt oxide (LiCoO₂), lithium nickel oxide (LiNiO₂), oxide of lithium, nickel, manganese, and cobalt (NMC: LiNiₚMn_{q}CoᵣO₂ (p + q + r = 1)), LiNiₚAl_{q}CoᵣO₂ (p + q + r = 1), lithium manganese oxide (LiMn₂O₄), different kind element substituent Li-Mn spinel represented by Li₁₊ₓMn_{2-x-y}M_{y}O₄ (x + y = 2, M = at least one type selected from a group consisting of Al, Mg, Co, Fe, Ni, and Zn), lithium titanate (oxide including Li and Ti), and lithium phosphate (LiMPO₄, M = at least one type selected from a group consisting of Fe, Mn, Co, and Ni). Examples of the conductive auxiliary agent include carbon black, natural graphite, carbon fiber, and carbon nanotube. Examples of the binder include nitrile-based polymer, polyester-based polymer, acrylic acid-based polymer, cellulose-based polymer, styrene-based polymer, styrene butadiene-based polymer, vinyl acetate-based polymer, urethane-based polymer, vinylidene fluoride-based polymer, and fluoroethylene-based polymer.

The negative electrodes 20 each include a negative electrode current collector 21 and negative electrode active material layers 22.

Example materials of the negative electrode current collector 21 include copper, copper alloy, nickel, and stainless steel.

The negative electrode active material layers 22 are layers that each form a metal layer including lithium upon charging. For the negative electrode active material layers 22, it is possible to use lithium, metal or semimetal forming alloy with lithium, carbon, and oxide. Examples of the metal and semimetal forming alloy with lithium include Mg, Si, Au, Ag, In, Ge, Sn, Pb, Al, and Zn. Note that it is sufficient that the negative electrodes 20 may each form a metal layer including lithium upon charging, and, instead of using the negative electrode active material layers 22, a metal layer including lithium may be formed on the negative electrode current collector 21.

The electrolytes 30 may be solid or liquid. In a case of liquid, a separator may be interposed between each of the positive electrodes 10 and each of the negative electrodes.

As a solid electrolyte, it is possible to use a sulfide solid electrolyte, an oxide solid electrolyte, a nitride solid electrolyte, or a halide solid electrolyte. Examples of the sulfide solid electrolyte include Li₂S-P₂S₅ and Li₂S-P₂S₅-LiI. The sulfide solid electrolyte may have an argyrodite-type crystal structure. Examples of the oxide solid electrolyte include NASICON-type oxide, garnet-type oxide, and perovskite-type oxide. An example of the NASICON-type oxide is oxide containing Li, Al, Ti, P, and O (for example, Li_{1.5}Al_{0.5}Ti_{1.5}(PO₄)₃). An example of the garnet-type oxide is oxide containing Li, La, Zr, and O (for example, Li₇La₃Zr₂O₁₂). An example of the perovskite-type oxide is oxide containing Li, La, Ti, and O (for example, LiLaTiO₃).

Examples of the liquid electrolyte include an organic solvent and an electrolyte. As the organic solvent, it is possible to use, for example, cyclic carbonate, chain carbonate, cyclic ether, chain ether, hydro fluoro ether, aromatic ether, sulfone, cyclic ester, chain carboxylic acid ester, or nitrile. Examples of the cyclic carbonate include ethylene carbonate, propylene carbonate, vinylene carbonate, and fluoroethylene carbonate. Examples of the chain carbonate include dimethyl carbonate, diethyl carbonate, and ethylmethyl carbonate. Examples of the cyclic ether include tetrahydrofuran, 2-methyl tetrahydrofuran, tetrahydropyran, 1,3-dioxolane, and 4-methyl 1,3-dioxolane. Examples of the chain ether include 1,2-dimethoxy ethane, 1,2-diethoxy ethane, ethoxymethoxy ethane, and diethyl ether. Examples of the hydro fluoro ether include 1,1,2,2-tetrafluoro ethyl-2,2,2-trifluoro ethyl ether, 1,1,2,2-tetrafluoro ethyl-2,2,3,3-tetrafluoro propyl ether, bis (2,2,2-trifluoro ethyl) ether, and 1,2-bis (1,1,2,2-tetrafluoro ethoxy) ethane. An example of the aromatic ether is anisole. Examples of the sulfone include sulfolane and methyl sulfolane. An example of the cyclic ester is γ-butyrolactone. Examples of the chain carboxylic acid ester include acetic ester, butyric acid ester, and propionic acid ester. Examples of the nitrile include acetonitrile and propionitrile. For the organic solvent, one type may be solely used or a combination of two or more types may be used.

The electrolyte includes lithium salt. Examples of the lithium salt include LiPF₆, LiBF₄, LiClO₄, LiAsF₆, LiCF₃SO₃, LiC(CF₃SO₂)₃, LiN(CF₃SO₂)₂(LiTFSI), LiN(FSO₂)₂(LiFSI), and LiBC₄O₈. For the lithium salt, one type may be solely used or a combination of two or more types may be used. A concentration of the electrolyte may fall, for example, within a range from 1.0 mol/L to 4.0 mol/L inclusive.

As the separator, it is possible to use, for example, porous body sheet or non-woven fabric sheet. Example materials of the porous body sheet include polyolefin such as polyethylene or polypropylene, aramid, polyimide, and fluororesin. Example materials of the non-woven fabric sheet include glass fiber and cellulose fiber.

It is possible to manufacture the positive electrode 10 with a method including, for example, a first covering layer forming step, a second covering layer forming step, a positive electrode active material layer forming step, and a pressing step.

The first covering layer forming step is a step of applying and drying an application liquid for forming a first covering layer on the surfaces of the positive electrode current collector 11 to form the first covering layers 15. The application liquid for forming the first covering layer includes, for example, a first solvent, a first binder dissolved in the first solvent, and electrically insulating particles dispersed in the first solvent.

The second covering layer forming step is a step of applying and drying an application liquid for forming a second covering layer to form the second covering layers 16 in such a manner that the first covering layers 15 are at least partially exposed. The application liquid for forming the second covering layer includes, for example, a second solvent, a second binder dissolved in the second solvent, and electrically conductive particles dispersed in the second solvent.

The positive electrode active material layer forming step is a step of applying and drying an application liquid for forming a positive electrode active material layer on respective surfaces of the second covering layers 16 excluding the end portions (the extension portions 16a of the second covering layers 16) where the second covering layers 16 cover the first covering layers 15 respectively to form the positive electrode active material layers 12. The application liquid for forming the positive electrode active material layer includes a solvent, a positive electrode active material, a conductive auxiliary agent, and a binder.

The pressing step is a step of pressing respective surfaces of the positive electrode active material layers 12. As the respective surfaces of the positive electrode active material layers 12 are pressed, the positive electrode active material layers 12 and the second covering layers 16 become minute, enhancing an electrically conductive property. The thickness of each of the second covering layers 16 becomes thinner than the thickness of each of the extension portions 16a of the second covering layers 16.

In the positive electrode 10 according to the present embodiment, which has such a configuration as described above, since the first covering layers 15 and the extension portions 16a of the second covering layers 16 cover the positive electrode current collector 11, even when lithium on the negative electrode 20 melts and flows toward the positive electrode 10 side, the flowed lithium comes into contact with the first covering layers 15 or the extension portions 16a of the second covering layers 16, and rarely comes into direct contact with the positive electrode current collector 11. Then, the surface resistance value of each of the first covering layers 15 and the second covering layers 16 at 20°C is higher than the surface resistance value of the positive electrode current collector 11 at 20°C. Therefore, compared with a case where the flowed lithium comes into contact with the positive electrode current collector 11, an amount of a current flowing between the positive electrode 10 and the negative electrode 20 is reduced, as the flowed lithium comes into contact with the first covering layers 15 and the extension portions 16a of the second covering layers 16, making it possible to reduce the amount of heat generated.

With the positive electrode 10 according to the present embodiment, since, when the surface resistance value of each of the first covering layers 15 at 20°C falls within the range described above, the surface resistance value of each of the first covering layers 15 at 20°C is high, it is possible to further reduce a current flowing between the positive electrode 10 and the negative electrode 20, as the flowed lithium comes into contact with the first covering layers 15, making it possible to securely reduce the amount of heat generated.

With the positive electrode 10 according to the present embodiment, since, when the thickness of each of the first covering layers 15 falls within the range described above, the thickness of each of the first covering layers 15 is thick, it is possible to further securely reduce a current flowing between the positive electrode 10 and the negative electrode 20, as the flowed lithium comes into contact with the first covering layers 15, making it possible to further securely reduce the amount of heat generated.

With the positive electrode 10 according to the present embodiment, when the surface resistance value of each of the second covering layers 16 at 20°C falls within the range described above, it is possible to maintain the electrically conductive property between the positive electrode current collector 11 and each of the positive electrode active material layers 12, and it is possible to reduce a current flowing between the positive electrode 10 and the negative electrode 20, when the flowed lithium comes into contact with the extension portions 16a of the second covering layers 16, making it possible to securely reduce the amount of heat generated.

With the positive electrode 10 according to the present embodiment, when the first covering layers 15 each include a binder, the first covering layers 15 can cover the positive electrode current collector 11 each with high adhesion. When the first covering layers 15 each include metal oxide particles or metal hydroxide particles, the surface resistance value of each of the first covering layers 15 at 20°C securely becomes high. Furthermore, when the metal oxide particles are aluminum oxide particles, and the metal hydroxide particles are hydroxide particles of aluminum or aluminum oxide, the surface resistance value of each of the first covering layers 15 at 20°C further securely becomes high. In addition and furthermore, when the mean particle diameter of the electrically insulating particles that are fine particles is 0.1 μm or less, the first covering layers 15 become further minute and strong, and are rarely broken even when lithium comes into contact with the layers.

With the positive electrode 10 according to the present embodiment, when the second covering layers 16 each include a binder, the extension portions 16a of the second covering layers 16 and the first covering layers 15 can respectively come into contact with each other each with high adhesion.

With the method for manufacturing the positive electrode 10 according to the present embodiment, since each of the first covering layers 15 and each of the second covering layers 16 are formed in this order, it is possible to manufacture industrially advantageously the positive electrode 10 for a secondary battery, in which the extension portions 16a of the second covering layers 16 are respectively disposed on the first covering layers 15.

### Second Embodiment

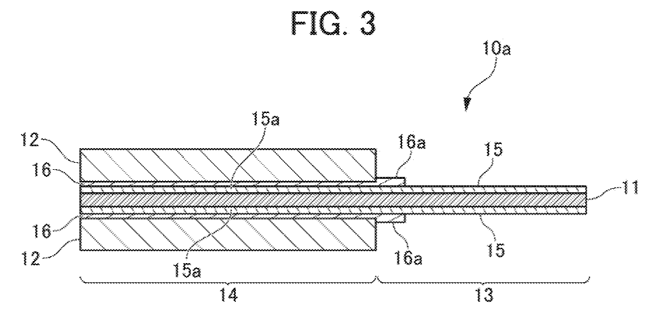

FIG. 3 is a cross-sectional view illustrating a second embodiment of the positive electrode that is usable in the present invention. An end portion of each of the first covering layers 15, the end portion being on the second covering layers 16 side, in a positive electrode 10a according to the present embodiment, has an extension portion 15a extending the end portion of each of the positive electrode active material layers 12 and covering the portion 14 of the positive electrode current collector 11, the portion being layered with the positive electrode active material layers 12. Since other configurations than the configuration described above are identical to the configurations in the positive electrode 10 according to the first embodiment, like reference numerals designate identical or corresponding configurations in the positive electrode 10 according to the first embodiment, and their detailed descriptions are omitted.

The extension portion 15a of each of the first covering layers 15 may be higher in electrically conductive property than each of the first covering layers 15 as the electrically conductive particles included in the second covering layers 16 are partially diffused. As the extension portion 15a of each of the first covering layers 15 is high in electrically conductive property, it is possible to enhance the electrically conductive property between the positive electrode current collector 11 and each of the positive electrode active material layers 12, making it possible to achieve charging and discharging of electricity even at a high rate. In addition, a thickness of the extension portion 15a of each of the first covering layers 15 may be thinner than the thickness of each of the first covering layers 15. As the thickness of the extension portion 15a of each of the first covering layers 15 is thin, it is possible to enhance the electrically conductive property between the positive electrode current collector 11 and each of the positive electrode active material layers 12, making it possible to achieve charging and discharging of electricity even at a high rate.

It is possible to manufacture the positive electrode 10a according to the present embodiment with a method including a first covering layer forming step, a second covering layer forming step, a positive electrode active material layer forming step, and a pressing step. The method for manufacturing the positive electrodes 10a will now be described herein with reference to an example case of using an elongated metallic foil as a material of the positive electrode current collector 11.

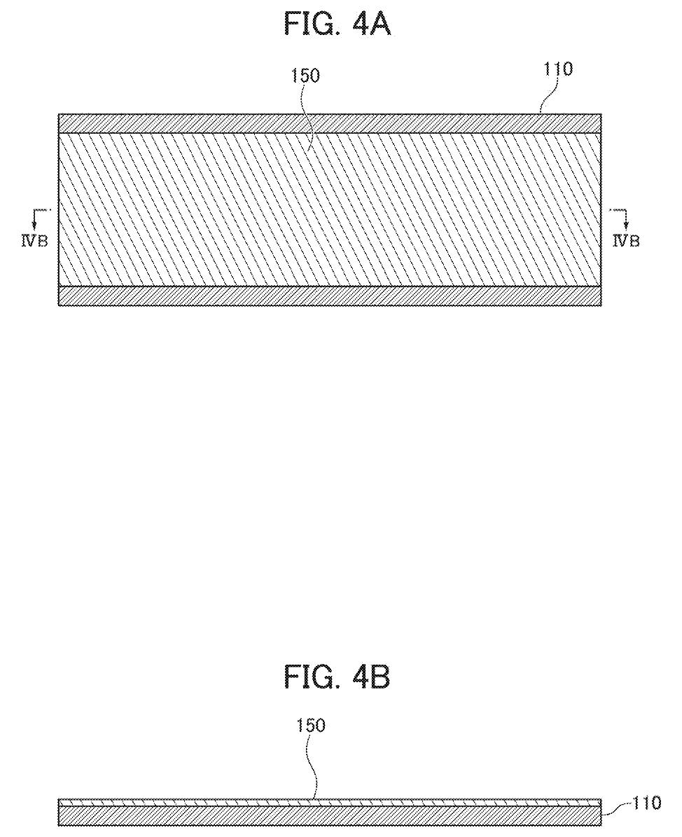

The first covering layer forming step is a step of continuously forming a first covering layer 150 in a longer direction of an elongated metallic foil 110, as illustrated in FIGS. 4A and 4B. It is possible to apply and dry an application liquid for forming a first covering layer to form the first covering layer 150. The application liquid for forming the first covering layer includes, for example, a first solvent, a first binder dissolved in the first solvent, and electrically insulating particles dispersed in the first solvent.

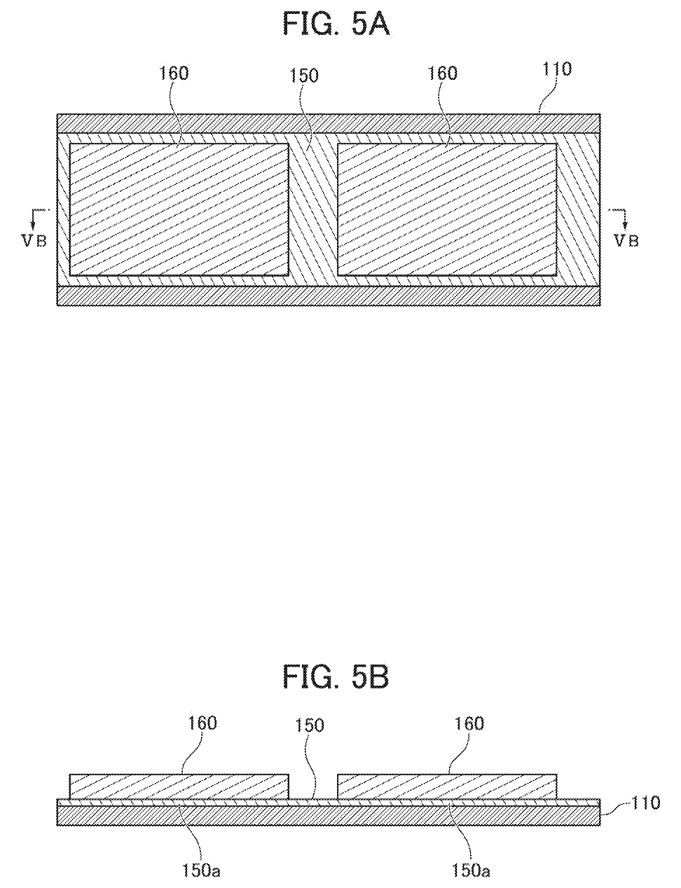

The second covering layer forming step is a step of intermittently forming second covering layers 160 in the longer direction of the elongated metallic foil 110 on a surface of the first covering layer 150, as illustrated in FIGS. 5A and 5B. Thereby, the first covering layer 150 is at least partially exposed. It is possible to apply and dry an application liquid for forming a second covering layer to form the second covering layers 160. The application liquid for forming the second covering layer includes, for example, a second solvent, a second binder dissolved in the second solvent, and electrically conductive particles dispersed in the second solvent. The first binder in the application liquid for forming the first covering layer may be highly soluble in the second solvent. As the first binder is dissolved in the second solvent, the electrically conductive particles in the application liquid for forming the second covering layer are diffused in extension portions 150a of the first covering layer 150, enhancing the extension portions 150a of the first covering layer 150 in electrically conductive property.

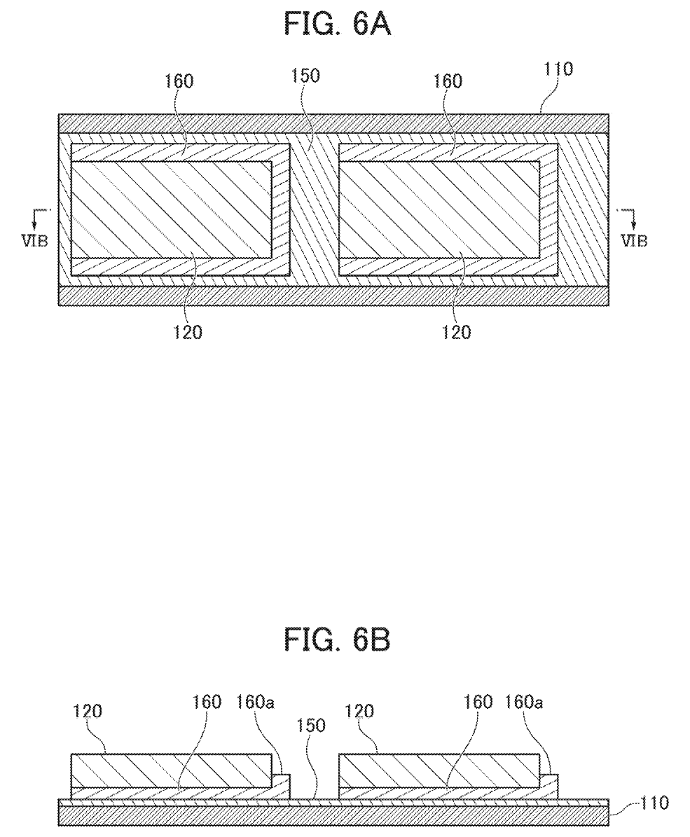

The positive electrode active material layer forming step is a step of intermittently forming positive electrode active material layers 120 in the longer direction of the elongated metallic foil 110 respectively on surfaces of the second covering layers 160, as illustrated in FIGS. 6A and 6B. It is possible to apply and dry an application liquid for forming a positive electrode active material layer to form the positive electrode active material layers 120. Surfaces of the formed positive electrode active material layers 120 are pressed in the pressing step. As the surfaces of the positive electrode active material layers 120 are pressed, a thickness of each of the second covering layers 160 and the extension portion 150a of the first covering layer 150 becomes thinner.

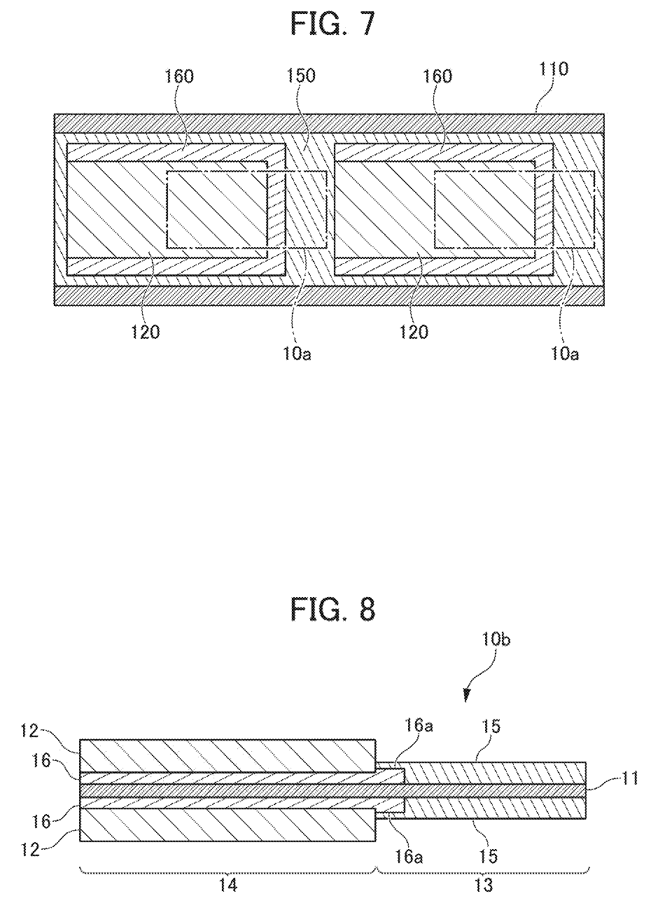

As a layered body including the elongated metallic foil 110, the first covering layer 150, the second covering layers 160, and the positive electrode active material layers 120, which are acquired as described above, is cut into shapes of the positive electrodes 10a, as illustrated in FIG. 7, it is possible to acquire the positive electrodes 10a. Note that the pressing step may be performed after the layered body is cut into the shapes of the positive electrodes 10a.

With the positive electrode 10a according to the present embodiment, which has such a configuration as described above, since the first covering layers 15 and the extension portions 16a of the second covering layers 16 cover the positive electrode current collector 11, even when lithium on the negative electrode 20 melts and flows toward the positive electrode 10 side, it is possible to reduce the amount of heat generated, similar to the positive electrode 10 according to the first embodiment. Furthermore, with the positive electrode 10a, since the first covering layers 15 respectively have the extension portions 15a extending the end portions of the positive electrode active material layers 12 and covering at least partially the positive electrode current collector, a gap is rarely created between each of the first covering layers 15 and each of the second covering layers 16, making it possible to further securely achieve covering of the positive electrode current collector 11.

With the method for manufacturing the positive electrode 10a according to the present embodiment, since the elongated metallic foil 110 is used and the first covering layer 150 and each of the second covering layers 160 are formed in this order, it is possible to continuously manufacture the positive electrode for the secondary battery, in which the extension portions of the second covering layers are respectively disposed on the first covering layers.

When, in the method for manufacturing the positive electrode 10a according to the present embodiment, the first binder in the application liquid for forming the first covering layer is highly soluble in the second solvent in the application liquid for forming the second covering layer, the first binder in the first covering layer 150 is easily dissolved when the second covering layers 160 are to be formed. As the first binder in the first covering layer 150 is dissolved, the electrically conductive particles in the application liquid for forming the second covering layer diffuse in the first covering layer 150, and the surface resistance value of the first covering layer that is positioned below the second covering layer at 20°C decreases.

### Third Embodiment

FIG. 8 is a cross-sectional view illustrating a third embodiment of the positive electrode that is usable in the present invention. In a positive electrode 10baccording to the present embodiment, the extension portions 16a of the second covering layers 16 are each disposed between each of the first covering layers 15 and the positive electrode current collector 11. Since other configurations than the configuration described above are identical to the configurations in the positive electrode 10 according to the first embodiment, like reference numerals designate identical or corresponding configurations in the positive electrode 10 according to the first embodiment, and their detailed descriptions are omitted.

It is possible to manufacture the positive electrode 10b according to the present embodiment with a method including a second covering layer forming step, a first covering layer forming step, a positive electrode active material layer forming step, and a pressing step. The method for manufacturing the positive electrodes 10b will now be described herein with reference to an example case of using an elongated metallic foil as a material of the positive electrode current collector 11.

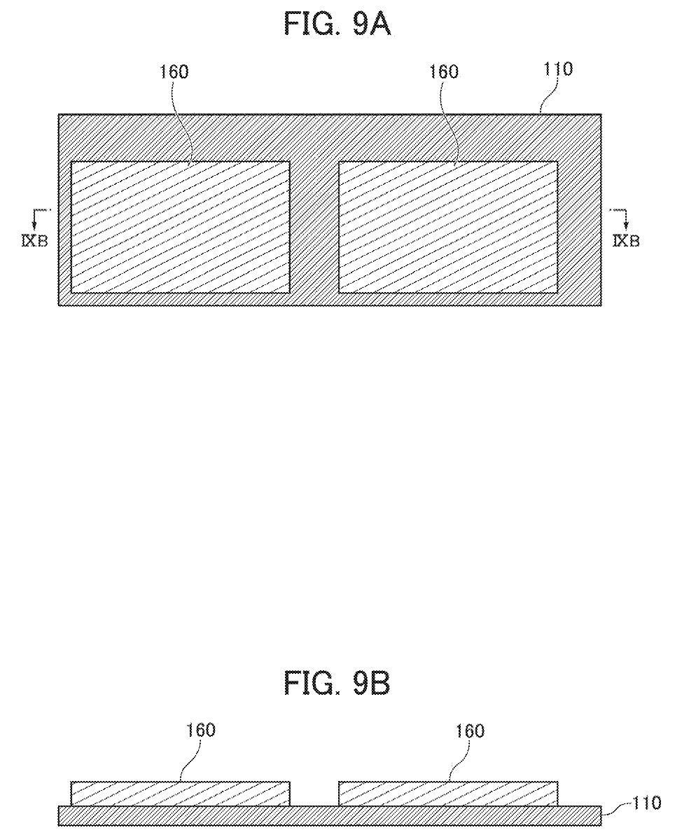

The second covering layer forming step is a step of intermittently forming the second covering layers 160 in the longer direction of the elongated metallic foil 110, as illustrated in FIGS. 9A and 9B. It is possible to apply and dry an application liquid for forming a second covering layer to form the second covering layers 160. The application liquid for forming the second covering layer includes, for example, a second solvent, a second binder dissolved in the second solvent, and electrically conductive particles dispersed in the second solvent.

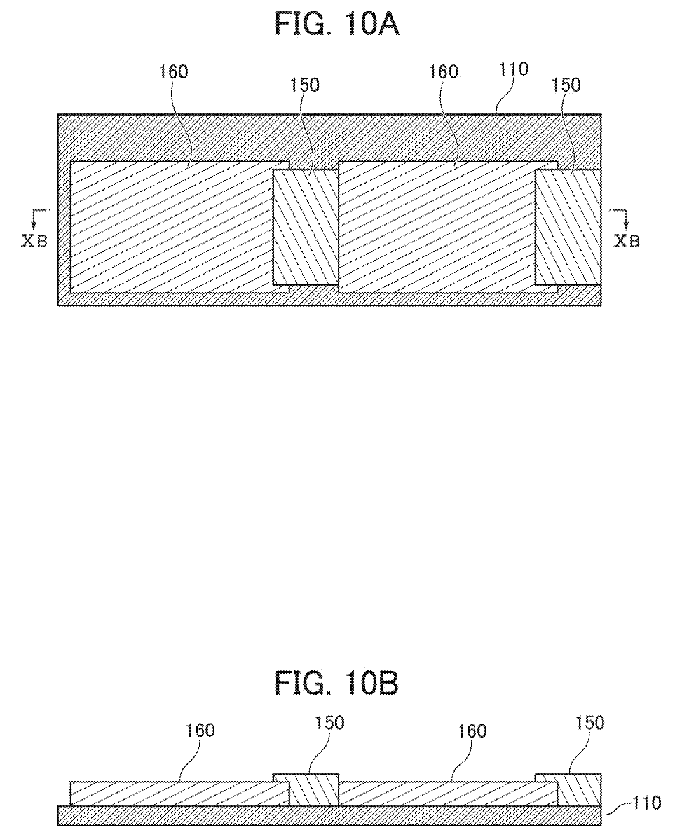

The first covering layer forming step is a step of intermittently forming the first covering layers 150 in the longer direction of the elongated metallic foil 110 in such a manner that the second covering layers 160 are respectively at least partially covered, as illustrated in FIGS. 10A and 10B. It is possible to apply and dry an application liquid for forming a first covering layer to form the first covering layers 150. The application liquid for forming the first covering layer includes, for example, a first solvent, a first binder dissolved in the first solvent, and electrically insulating particles dispersed in the first solvent. The second binder in the application liquid for forming the second covering layer may be poorly soluble in the first solvent in the application liquid for forming the first covering layer. As the second binder is not dissolved in the first solvent, the electrically conductive particles in the extension portions 160a of the second covering layers 160 are rarely diffused in the first covering layers 150, and the first covering layers 150 are less likely to lower in electrically insulating property.

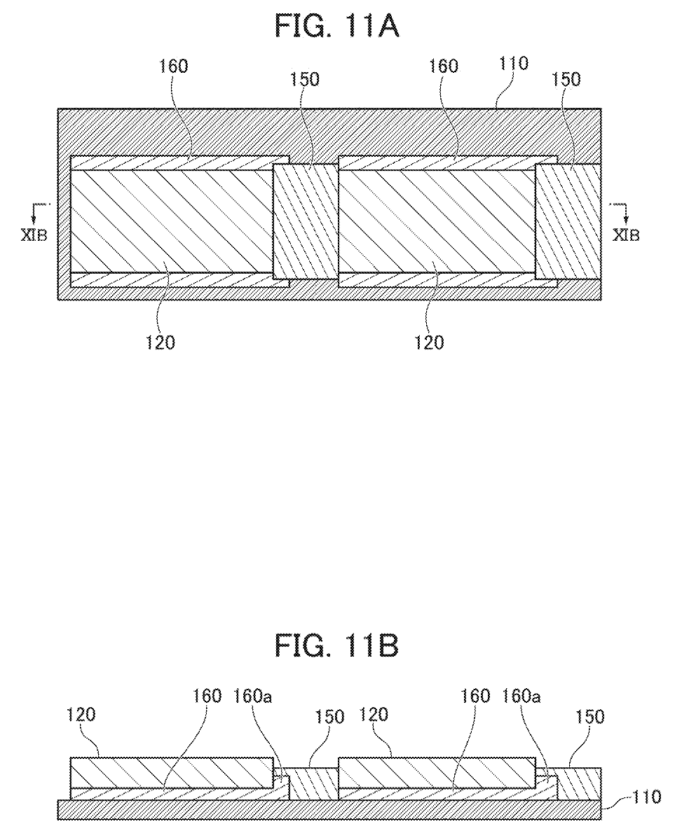

The positive electrode active material layer forming step is a step of intermittently forming the positive electrode active material layers 120 in the longer direction of the elongated metallic foil 110 respectively on the surfaces of the second covering layers 160, as illustrated in FIGS. 11A and 11B. It is possible to apply and dry an application liquid for forming a positive electrode active material layer to form the positive electrode active material layers 120. The surfaces of the formed positive electrode active material layers 120 are pressed in the pressing step.

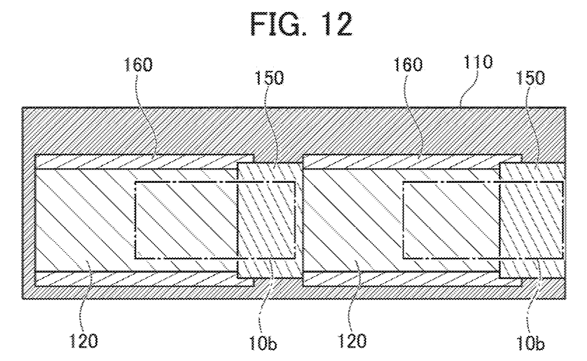

As a layered body including the elongated metallic foil 110, the second covering layers 160, the first covering layers 150, and the positive electrode active material layers 120, which are acquired as described above, is cut into shapes of the positive electrodes 10b, as illustrated in FIG. 12, it is possible to acquire the positive electrodes 10a. Note that the pressing step may be performed after the layered body is cut into the shapes of the positive electrodes 10b.

With the positive electrode 10b according to the present embodiment, which has such a configuration as described above, since the first covering layers 15 and the extension portions 16a of the second covering layers 16 cover the positive electrode current collector 11, even when lithium on the negative electrode 20 melts and flows toward the positive electrode 10 side, it is possible to reduce the amount of heat generated, similar to the positive electrode 10 according to the first embodiment. Furthermore, in the positive electrode 10b, since the extension portions 16a of the second covering layers 16 are each disposed between each of the first covering layers 15 and the positive electrode current collector 11, and the first covering layers 15 are respectively disposed on outer sides, the flowed lithium easily comes into contact with the first covering layers 15. It is possible to securely reduce the amount of heat generated as the flowed lithium comes into contact with the first covering layers 15. Note that, although, in the present embodiment, the extension portions 16a of the second covering layers 16 partially cover the portion 13 of the positive electrode current collector 11, the portion being not layered with the positive electrode active material layers 12, it is sufficient that the extension portions 16a of the second covering layers 16 cover wholly the portion 13 of the positive electrode current collector 11, the portion being not layered with the positive electrode active material layers 12.

With the method for manufacturing the positive electrode 10b according to the present embodiment, since the elongated metallic foil 110 is used and the first covering layers 150 and the second covering layers 160 are each formed in this order, it is possible to continuously manufacture the positive electrode 10b for the secondary battery, in which the extension portions 16a of the second covering layers 16 are respectively disposed between each of the first covering layers 15 and the positive electrode current collector 11.

When, in the method for manufacturing the positive electrode 10b according to the present embodiment, the second binder in the application liquid for forming the second covering layer is poorly soluble in the first solvent in the application liquid for forming the first covering layer, the second binder in each of the second covering layers 160 are rarely dissolved when the first covering layers 150 are to be formed. Since the first binder in each of the second covering layers 160 is not dissolved, the electrically conductive particles rarely diffuse in the first covering layers 150. The positive electrode 10b to be acquired is therefore high in surface resistance value of each of the first covering layers 15 at 20°C. Note that, although, in the present embodiment, the elongated metallic foil 110 has been used as the positive electrode current collector, a metallic foil adjusted to conform to a size of the positive electrode current collector 11 in the positive electrode 10b may be used.

Although the preferable embodiments of the present invention have been described, the present invention is not limited to the embodiments described above, and the present invention still includes a modification or an improvement falling within a range allowing the object of the present invention to be achieved. For example, although, in the present embodiments, the positive electrode active material layers 12 are layered on both the surfaces of the positive electrode current collector 11, it is sufficient that the positive electrode active material layer 12 be formed on a surface on the negative electrode 20 side, and be formed on one surface of the positive electrode current collector 11.

### EXPLANATION OF REFERENCE NUMERALS

1 Secondary battery

10, 10a, 10b Positive electrode

11 Positive electrode current collector

12 Positive electrode active material layer

13 Portion not layered with positive electrode active material layer

14 Portion layered with positive electrode active material layer

15 First covering layer

16 Second covering layer

20 Negative electrode

21 Negative electrode current collector

22 Negative electrode active material layer

30 Electrolyte

110 Elongated metallic foil

120 Positive electrode active material layer

150 First covering layer

160 Second covering layer

What is claimed is:

1. A secondary battery comprising:
a positive electrode;
a negative electrode; and
an electrolyte,
wherein
the negative electrode forms a metal layer including lithium upon charging,
the positive electrode includes
a positive electrode current collector,
a positive electrode active material layer layered at least partially on a surface of the positive electrode current collector,
a first covering layer covering a portion of the positive electrode current collector, the portion being not layered with the positive electrode active material layer, and
a second covering layer disposed between the positive electrode current collector and the positive electrode active material layer,
a surface resistance value of the first covering layer at 20°C is higher than a surface resistance value of the second covering layer at 20°C,
the surface resistance value of the second covering layer at 20°C is higher than a surface resistance value of the positive electrode current collector at 20°C,
an end portion of the second covering layer, the end portion being on a first covering layer side, has an extension portion that extends beyond an end portion of the positive electrode active material layer toward the first covering layer side, and
the extension portion of the second covering layer is disposed on the first covering layer or between the first covering layer and the positive electrode current collector.

2. The secondary battery according to claim 1, wherein
the extension portion of the second covering layer is disposed on the first covering layer, and
an end portion of the first covering layer, the end portion being on a second covering layer side, has an extension portion that extends beyond the end portion of the positive electrode active material layer and covers at least partially the positive electrode current collector.

3. The secondary battery according to claim 1, wherein the surface resistance value of the first covering layer at 20°C is 10 times or more of the surface resistance value of the positive electrode current collector at 20°C.

4. The secondary battery according to claim 1, wherein a thickness of the first covering layer falls within a range from 0.1 μm or more to 10 μm or less.

5. The secondary battery according to claim 1, wherein the surface resistance value of the second covering layer at 20°C falls within a range from 10 times or more of the surface resistance value of the positive electrode current collector at 180°C.

6. The secondary battery according to claim 1, wherein the first covering layer includes electrically insulating particles and a binder.

7. The secondary battery according to claim 6, wherein the electrically insulating particles are metal oxide particles or metal hydroxide particles.

8. The secondary battery according to claim 7, wherein
the metal oxide particles are oxide particles of aluminum, and
the metal hydroxide particles are hydroxide particles of aluminum or aluminum oxide.

9. The secondary battery according to claim 6, wherein a mean particle diameter of the electrically insulating particles is 0.1 μm or less.

10. The secondary battery according to claim 1, wherein the second covering layer includes electrically conductive particles and a binder.

11. A method for manufacturing a positive electrode for a secondary battery, comprising:
applying and drying an application liquid for forming a first covering layer on a surface of a positive electrode current collector to form the first covering layer;
applying and drying an application liquid for forming a second covering layer to form the second covering layer in such a manner that the first covering layer is at least partially exposed;
applying and drying an application liquid for forming a positive electrode active material layer on a surface of the second covering layer, excluding an end portion where the second covering layer covers the first covering layer, to form the positive electrode active material layer; and
pressing a surface of the positive electrode active material layer.

12. The method for manufacturing the positive electrode for the secondary battery, according to claim 11, wherein the application liquid for forming the first covering layer includes a first solvent, a first binder dissolved in the first solvent, and electrically insulating particles dispersed in the first solvent,
the application liquid for forming the second covering layer includes a second solvent, a second binder dissolved in the second solvent, and electrically conductive particles dispersed in the second solvent, and
the first binder is highly soluble in the second solvent.

13. The method for manufacturing the positive electrode for the secondary battery, according to claim 11, wherein
the positive electrode current collector has an elongated shape,
the first covering layer is continuously formed in a longer direction of the elongated positive electrode current collector,
the second covering layer is intermittently formed on a surface of the first covering layer in the longer direction of the elongated positive electrode current collector in such a manner that the first covering layer is at least partially exposed,
the positive electrode active material layer is intermittently formed on a surface of the second covering layer in the longer direction of the elongated positive electrode current collector, and
cutting into a shape of the positive electrode is then performed.

14. A method for manufacturing a positive electrode for a secondary battery, comprising:
applying and drying an application liquid for forming a second covering layer partially on a surface of a positive electrode current collector to form the second covering layer;
applying and drying an application liquid for forming a first covering layer to form the first covering layer in such a manner that the second covering layer is at least partially covered;
applying and drying an application liquid for forming a positive electrode active material layer on a surface of the second covering layer, excluding an end portion where the first covering layer covers the second covering layer, to form the positive electrode active material layer; and
pressing a surface of the positive electrode active material layer.

15. The method for manufacturing the positive electrode for the secondary battery, according to claim 14, wherein
the application liquid for forming the first covering layer includes a first solvent, a first binder dissolved in the first solvent, and electrically insulating particles dispersed in the first solvent,
the application liquid for forming the second covering layer includes a second solvent, a second binder dissolved in the second solvent, and electrically conductive particles dispersed in the second solvent, and
the second binder is poorly soluble in the first solvent.

16. The method for manufacturing the positive electrode for the secondary battery, according to claim 14, wherein
the positive electrode current collector has an elongated shape,
the second covering layer is intermittently formed in a longer direction of the elongated positive electrode current collector,
the first covering layer is intermittently formed in the longer direction of the elongated positive electrode current collector in such a manner that the second covering layer is at least partially covered,
the positive electrode active material layer is intermittently formed on a surface of the second covering layer in the longer direction of the elongated positive electrode current collector, and
cutting into a shape of the positive electrode is then performed.
